(19) United States
(12) Patent Application Publication
(10) Pub. No.: US 2012/0119998 A1
(43) Pub. Date: May 17, 2012

(54) SERVER DEVICE, DISPLAY OPERATION TERMINAL, AND REMOTE CONTROL SYSTEM

(75) Inventor: Kazuhiro Sato, Tokyo (JP)

(73) Assignee: SONY CORPORATION, Tokyo (JP)

(21) Appl. No.: 13/288,329

(22) Filed: Nov. 3, 2011

(30) Foreign Application Priority Data
Nov. 11, 2010 (JP) P2010-252749

(51) Int. Cl. G06F 3/02

(52) U.S. Cl. 345/169

(57) ABSTRACT

Systems and methods for operating an operational terminal and a server are provided. In various aspects, an operational terminal may transmit information regarding the operational terminal and a remote commander for controlling a device. A server may receive the information, and transmit display information and signal code information to the operational terminal. The display information may include information for displaying operational elements of the remote commander on a display screen. The signal code information may include control information corresponding to each of the operational elements. The operational terminal may display the operational elements on a display screen for selection by a user. Upon selection of a particular operational element, the operational terminal may transmit a control signal for remotely controlling an operation of the device, where the control signal may be transmitted in accordance with the received signal code information corresponding to the selected operational element.

### CROSS-REFERENCE TO RELATED APPLICATION

The present application claims priority from Japanese Patent Application No. JP 2010-252749 filed in the Japanese Patent Office on Nov. 11, 2010, the entire content of which is incorporated herein by reference.

### BACKGROUND OF THE INVENTION

The present disclosure relates to a server device, a display operation terminal, and a remote control system.

In the related art, electronic devices such as television devices and recording/playback devices come with dedicated remote commanders. By operating such dedicated remote commander and causing the remote commander to transmit an infrared signal, a user is able to control the operation of a remote electronic device.

Further, recently, techniques for causing a displaying terminal with a display function to function as a remote commander for an electronic device have also been proposed. For example, JP 2007-511128A discloses a display terminal that captures an image of a remote commander, acquires a control signal corresponding to each operation button on the image of the remote commander, and, when an operation button on the image is selected, transmitting a control signal corresponding to the operation button.

In addition, JP 4491995B discloses a display terminal that captures an image of an electronic device, identifying the electronic device from the image of the electronic device, acquiring from a server an operation display screen for the electronic device and a control signal corresponding to each operation button on the operation display screen, and, when an operation button on the operation display screen is selected, transmitting a control signal corresponding to the operation button.

### BRIEF SUMMARY OF THE INVENTION

However, in regard to the display terminals of the related art, the arrangement of operation buttons on the operation display screens has been uniform. Therefore, it is concerned that some users may feel that such operation display screens are difficult to use. For example, it is considered that an operation display screen that implements a multi-functional remote commander paved with many operation buttons is difficult to use for users who are not used to the operation. Meanwhile, when a display terminal does not have a touch panel function, button selection is considered to be implemented with a cursor movement. However, the button selection implemented with a cursor movement is complex.

In light of the foregoing, it is desirable to provide a server device, a display operation terminal, and a remote control system that are novel and improved and are capable of displaying a user-friendly operation display screen.

In one aspect, an operational terminal for controlling an operation of a device is provided. The operational terminal may include a processor configured to transmit operational terminal information regarding the operational terminal and type information of a remote commander associated with the device. The processor may also be configured to receive display information for displaying one or more operational elements associated with the remote commander and signal code information respectively corresponding to each of the one or more operational elements. The display information received by the processor may be based on the operational terminal information and the type information transmitted by the operational terminal. The processor may display, based on the display information, the one or more operational elements for selection by a user on a display screen. Based on the selection of a particular one of the one or more operational elements displayed on the display screen, the processor may also transmit a control signal for controlling an operation of the device, where the processor may transmit the control signal in accordance with the signal code information respectively corresponding to the selected particular one of the one or more operational elements.

In one aspect, the processor may determine the type information of the remote commander based on an analysis of an image of the remote commander. The image of the remote commander may include information for identifying the remote commander and the one or more operational elements associated with the remote commander. In one embodiment, the operation terminal may also include a shooting unit for capturing the image of the remote commander.

In one aspect, the operational terminal may also include a display unit. In addition, the operational terminal information may include information regarding the display unit associated with the operational terminal. Furthermore, the processor may be further configured to display the display screen received by the processor on the display unit. In one embodiment, the display unit may include a touch panel, and the display screen may be displayed on the touch panel of the display unit. Alternatively or in addition, in one aspect the operational terminal may also include one or more hardware (or software) buttons for selecting one of the operational elements displayed on the display screen. Yet further, in another aspect the operational terminal may also include a microphone, and the processor may be configured to receive the selection of the particular one of operational elements displayed on the display screen by performing speech processing on speech captured by the microphone.

In various aspects, the operational terminal may be configured as a personal computer, a phone, an electronic notebook, a tablet, a media device, a remote control, or a gaming machine.

In another aspect, a server device including a processor configured to receive operational terminal information of an operational terminal and type information of a remote commander is provided. The processor may be further configured to acquire, based on the received type information of the remote commander, signal code information that respectively corresponds to each of one or more operational elements associated with the remote commander. The processor may also determine, based on the received operational terminal information, display information for displaying the one or more operational elements associated with the remote commander. The processor may then be configured to transmit the display information and the signal code information respectively corresponding to each of the one or more operational elements.

In one aspect, the operational terminal information received by the server may include information regarding a size of a display screen, and the server's processor may further be configured to determine the display information based on the size of the display screen. For example, in one embodiment the display information transmitted by the server may include coordinate data for displaying the one or more operational elements on the display screen. Furthermore, the display information transmitted by the server may also include a simplified GUI image of the remote commander.

In one aspect, the type information of the remote commander received by the server may include an image of the remote commander. Furthermore, the type information received by the server may also include model information and/or manufacturer information of the remote commander. Such model/manufacturer information may be received in image or text format.

A method for operating an operational terminal is provided. The method may include transmitting operational terminal information regarding the operational terminal and type information of a remote commander, and receiving display information for displaying one or more operational elements associated with the remote commander and signal code information respectively corresponding to each of the one or more operational elements. The received display information may be based on the operational terminal information and the type information. The method may also include displaying, using a processor and based on the display information, the one or more operational elements for selection by a user on a display screen; and, transmitting, based on the selection of a particular one of the one or more operational elements displayed on the display screen, a control signal for controlling an operation of a device, the control signal being transmitted in accordance with the signal code information respectively corresponding to the selected particular one of the one or more operational elements.

A non-transitory computer-readable medium storing computer executable instructions of a program is provided. The instructions, when executed by a control unit, may configure the control unit to transmit operational terminal information regarding the operational terminal and type information of a remote commander, and receive display information for displaying one or more operational elements associated with the remote commander and signal code information respectively corresponding to each of the one or more operational elements. As before, the display information may be based on the operational terminal information and the type information. The instructions may further configure the control unit to display, based on the display information, the one or more operational elements for selection by a user on a display screen and, transmit, based on the selection of a particular one of the one or more operational elements displayed on the display screen, a control signal for controlling an operation of a device, the control signal being transmitted in accordance with the signal code information respectively corresponding to the selected particular one of the one or more operational elements.

A method for operating a server is provided. The method may include receiving operational terminal information of an operational terminal and type information of a remote commander, and acquiring, based on the type information of the remote commander, signal code information respectively corresponding to each of one or more operational elements associated with the remote commander. The method may further include determining, using a processor and based on the operational terminal information, display information for displaying the one or more operational elements associated with the remote commander; and, transmitting the display information and the signal code information respectively corresponding to each of the one or more operational elements.

A non-transitory computer-readable medium storing computer executable instructions of a program is provided. The instructions, when executed by a control unit, may configure the control unit to receive operational terminal information of an operational terminal and type information of a remote commander and, acquire, based on the type information of the remote commander, signal code information respectively corresponding to each of one or more operational elements associated with the remote commander. The instructions may further configure the control unit to determine, based on the operational terminal information, display information for displaying the one or more operational elements associated with the remote commander and, transmit the display information and the signal code information respectively corresponding to each of the one or more operational elements.

According to the embodiments of the present disclosure described above, a user-friendly operation display screen can be displayed.

### BRIEF DESCRIPTION OF THE DRAWINGS

FIG. 1 is an explanatory diagram showing the configuration of a remote control system 1 in accordance with an embodiment of the present disclosure;

FIG. 2A is an explanatory diagram showing the appearance of a plane of a portable terminal;

FIG. 2B is an explanatory diagram showing the appearance of the opposite plane of the portable terminal;

FIG. 3 is a block diagram showing the hardware configuration of the portable terminal;

FIG. 4 is a functional block diagram showing the configurations of a portable terminal and a server device in accordance with the first embodiment;

FIG. 5 is an explanatory diagram showing a specific example of code data stored in a server storage unit;

FIG. 6 is an explanatory diagram showing an exemplary coordinate system of a remote commander;

FIG. 7A is an explanatory diagram showing a configuration example of a remote commander;

FIG. 7B is an explanatory diagram showing a configuration example of a remote commander;

FIG. 8 is an explanatory diagram showing a specific example of a shot image of a remote commander 40 displayed on an operation display unit;

FIG. 9 is a sequence diagram showing the operations of the portable terminal and the server device in accordance with the first embodiment;

FIG. 10 is a functional block diagram showing the configurations of a portable terminal and a server device in accordance with the second embodiment;

FIG. 11 is an explanatory diagram showing a specific example of a simplified version GUI;

FIG. 12 is an explanatory diagram showing a specific example of code data in accordance with the second embodiment;

FIG. 13 is an explanatory diagram showing a specific example of another simplified version GUI;

FIG. 14 is a sequence diagram showing the operations of the portable terminal and the server device in accordance with the second embodiment;

FIG. 15 is an explanatory diagram showing the operations of a portable terminal and a server device in accordance with the third embodiment;

FIG. 16 is an explanatory diagram showing an exemplary range of remote commanders shot by a portable terminal;

FIG. 17 is an explanatory diagram showing a specific example of a selection screen for a model category; and

FIG. 18 is an explanatory diagram showing the configuration of a remote control system in accordance with the fourth embodiment of the present disclosure.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted by the same reference numerals, and repeated explanation of these structural elements is omitted.

In addition, in this specification and the drawings, a plurality of structural elements that have substantially the same function and structure and are denoted by the same reference numerals may be followed by different alphabets so that they can be easily distinguished. However, when there is no need to particularly distinguish between each of the plurality of structural elements that have substantially the same function and structure, only reference numerals will be assigned.

The “DETAILED DESCRIPTION OF THE EMBODIMENTS” will be described in accordance with the following order.

1. Basic Configuration of Remote Control System

2. First Embodiment
2-1. Functions of Portable Terminal and Server Device in accordance with First Embodiment
2-2. Operations of Portable Terminal and Server Device in accordance with First Embodiment

3. Second Embodiment
3-1. Functions of Portable Terminal and Server Device in accordance with Second Embodiment
3-2. Operations of Portable Terminal and Server Device in accordance with Second Embodiment

4. Third Embodiment

5. Fourth Embodiment

6. Conclusion

### 1. Basic Configuration of Remote Control System

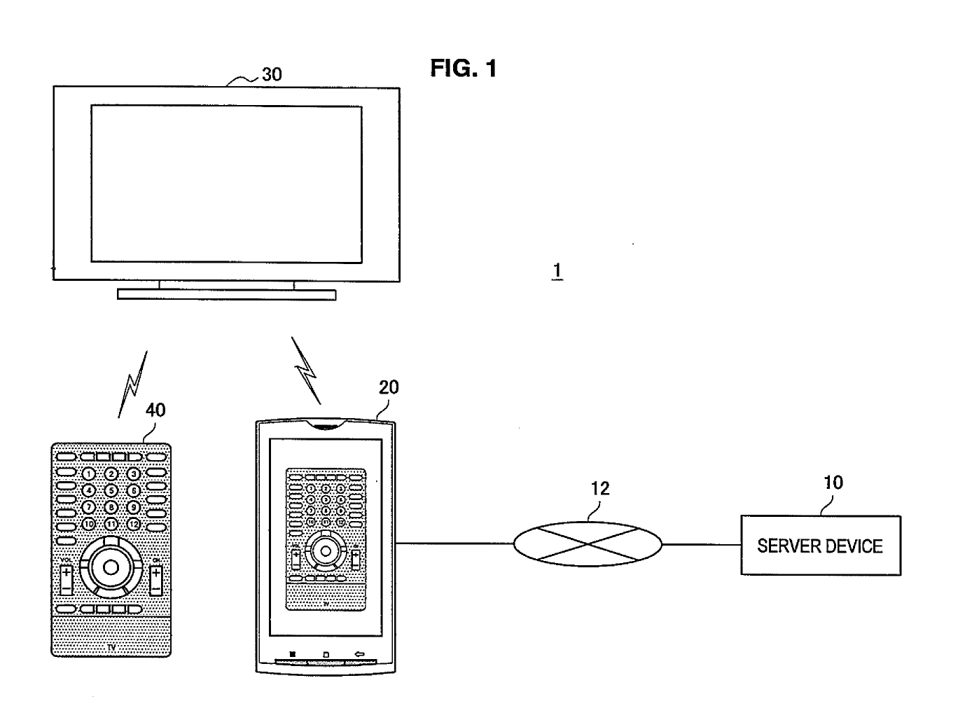

First, the basic configuration of a remote control system 1 that is common to the first embodiment to the third embodiment of the present disclosure will be described with reference to FIGS. 1 to 3.

FIG. 1 is an explanatory diagram showing the configuration of a remote control system 1 in accordance with an embodiment of the present disclosure. As shown in FIG. 1, the remote control system 1 in accordance with an embodiment of the present disclosure includes a server device 10, a communications network 12, a portable terminal 20, a television device 30, and a remote commander 40.

The television device 30 displays various screens in accordance with control signals transmitted from the remote commander 40. For example, the television device 30 displays content that is specified by a control signal transmitted from the remote commander 40 among content that is broadcast, content that is externally input, and the like. Further, in the remote control system 1 in accordance with an embodiment of the present disclosure, the portable terminal 20 can also transmit a control signal for controlling the operation of the television device 30.

Although FIG. 1 shows the television device 30 as an exemplary user device to be remotely controlled, the user device is not limited to the television device 30. Examples of user devices to be remotely controlled include playback devices for optical discs such as DVD (Digital Versatile Disc) or BD (Blu-Ray Disc®), air conditioners, lighting devices, blinds, shutters, game machines, imaging devices, automobiles, and vehicle-mounted devices.

The remote commander 40 is mounted with operation buttons, and transmits a control signal corresponding to an operation button pressed by a user. For example, the remote commander 40, when an operation button “POWER” is pressed by a user, transmits a control signal for switching on/off of the television device 30. Note that the remote commander 40 is sold as an accessory of the television device 30, for example.

Operation elements that are mounted on the remote commander 40 are not limited to the operation buttons. For example, a switch-type, lever-type, or dial-type user interface can be mounted on the remote commander 40. In addition, the remote commander 40 can transmit an infrared signal or a radio signal as a control signal.

The communications network 12 is a wired or wireless transmission channel for information that is transmitted from a device connected to the communications network 12. For example, the communications network 12 can include a public line network such as the Internet, a telephone line network, or a satellite communications network; various types of LAN (Local Area Network) including Ethernet®; or WAN (Wide Area Network). In addition, the communications network 12 can include a dedicated line network such as IP-VPN (Internet Protocol-Virtual Private Network).

The server device 10 stores, for various remote commanders, code data obtained by associating each operation button of each type of remote commander with a signal code. In addition, the server device 10, upon receiving information indicating the type of the remote commander 40 from the portable terminal 20 via the communications network 12, transmits code data corresponding to the type of the remote commander 40 to the portable terminal 20.

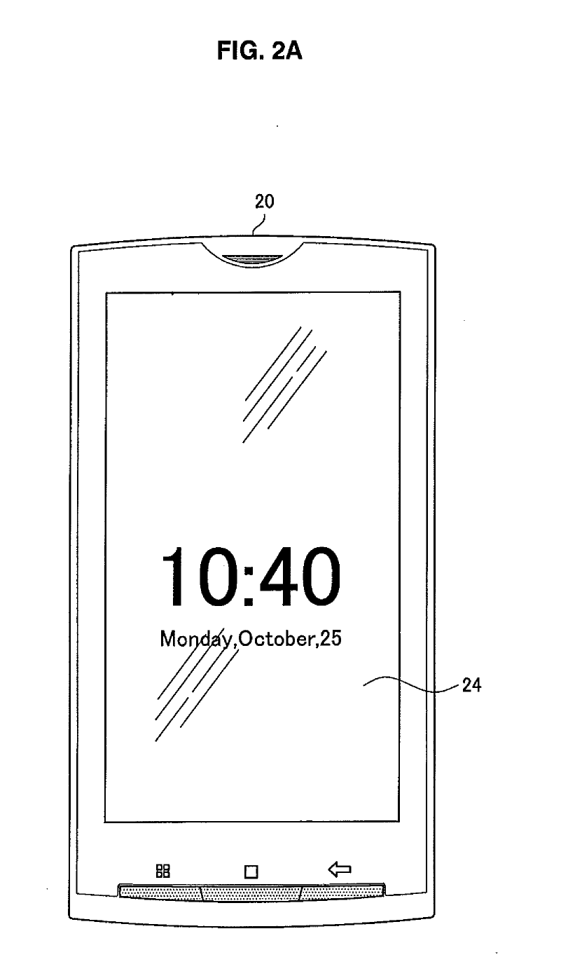

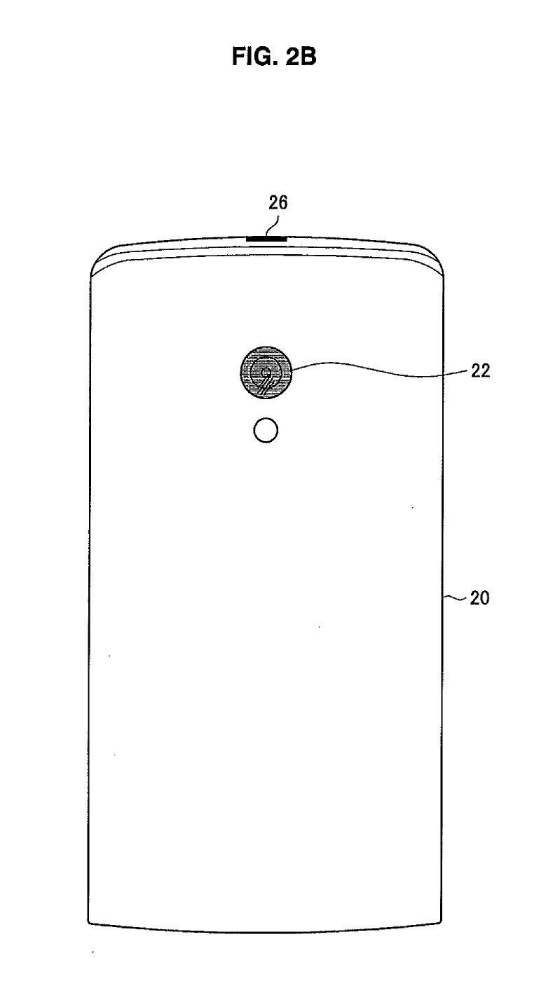

The portable terminal 20 is a display operation terminal having a display function and an operation detection function. Hereinafter, the appearance/configuration of the portable terminal 20 will be specifically described with reference to FIG. 2.

### (Appearance/Configuration of Portable Terminal 20)

FIG. 2A is an explanatory diagram showing the appearance of a plane of the portable terminal 20. FIG. 2B is an explanatory diagram showing the appearance of the opposite plane of the portable terminal 20. As shown in FIGS. 2A and 2B, the portable terminal 20 includes a shooting unit 22, an operation display unit 24, and a signal transmission unit 26.

The shooting unit 22 includes a shooting lens, a zoom lens, a signal conversion unit, and the like. The shooting lens and the zoom lens condense light emitted from a subject, and form an image of the subject at a signal conversion unit such as a CCD (Charge Coupled Device) or a CMOS (Complementary Metal Oxide Semiconductor). The signal conversion unit converts the image of the subject formed by the shooting lens and the zoom lens into an electrical image signal.

The operation display unit 24 includes a function of a display unit that displays a screen and a function of an operation unit that detects a user operation. For example, the operation display unit 24 in accordance with an embodiment of the present disclosure displays an operation display screen for remotely controlling the television device 30, and detects a user operation on the operation display screen.

Although this specification will describe an example in which the operation display unit 24 is a touch panel including the functions of a display unit and an operation unit, the operation display unit 24 is not limited to the touch panel. For example, the function of the display unit and the function of the operation unit of the operation display unit 24 can be implemented separately. In such a case, pressing buttons, for example, can be provided on the portable terminal 20 as an operation unit.

The signal transmission unit 26 transmits a control signal in accordance with a user operation on the operation display unit 24. Specifically, the signal transmission unit 26 can, when an operation button is selected by a user from an operation display screen displayed on the operation display unit 24, transmits a control signal corresponding to the operation button. Note that the signal transmission unit 26 can transmit an infrared signal or a radio signal as a control signal.

Although FIGS. 1, 2A, and 2B each show a portable phone as an example of the portable terminal 20 functioning as a display operation terminal, the portable terminal 20 is not limited to the portable phone. For example, the portable terminal 20 can be a display operation terminal such as a PC (Personal Computer), an imaging device, an electronic notebook, a portable music playback device, a portable image processing device, or a portable game machine.

### (Hardware Configuration of Portable Terminal 20)

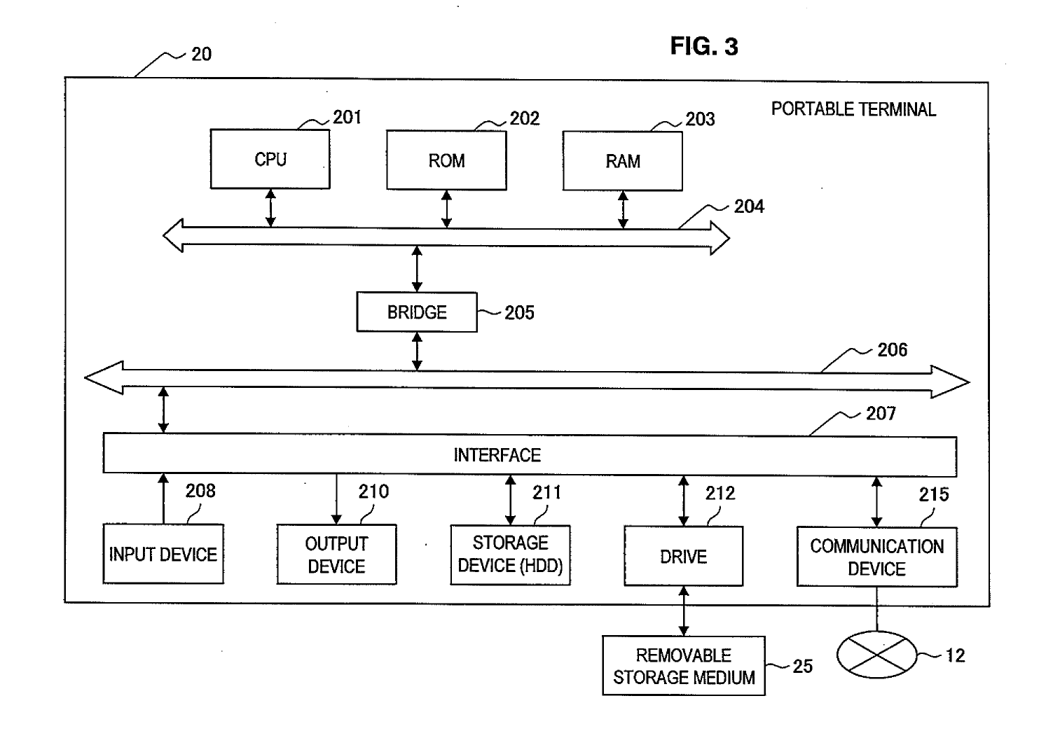

Described above is the appearance/configuration of the portable terminal 20. Next, the hardware configuration of the portable terminal 20 will be described with reference to FIG. 3.

FIG. 3 is a block diagram showing the hardware configuration of the portable terminal 20. The portable terminal 20 includes a processor, such as a CPU (Central Processing Unit) 201. The portable terminal 20 also includes a ROM (Read Only Memory, a type of non-transitory computer-readable memory) 202, RAM (Random Access Memory) 203, and a host bus 204. The portable terminal 20 also includes a bridge 205, an external bus 206, an interface 207, an input device 208, an output device 210, a non-transitory computer-readable storage device (HDD) 211, a drive 212, and a communication device 215. In one aspect, the server device 10 may also be configured as shown in FIG. 3. For example, like the portable terminal 20, the server device 10 may also include a processor or CPU (Central Processing Unit) 201, ROM (Read Only Memory) 202, RAM (Random Access Memory) 203, and a host bus 204. Further, the server device 10 may also include a bridge 205, an external bus 206, an interface 207, an input device 208, an output device 210, a non-transitory computer-readable storage device (HDD) 211, a drive 212, and a communication device 215.

The processor or CPU 201 functions as an arithmetic processing unit and a control unit, and controls the entire operations within the portable terminal 20 (or server 10) in accordance with various programs stored in a non-transitory computer-readable medium (e.g., ROM 202 or storage device 211). The CPU 201 can also be a microprocessor. The ROM 202 stores programs, operation parameters, and the like used by the CPU 201. The RAM 203 temporarily stores programs that are used during execution of the CPU 201, parameters that change as appropriate during the execution, and the like. These components are mutually connected by the host bus 204 including a CPU bus and the like.

The host bus 204 is connected to the external bus 206 such as a PCI (Peripheral Component Interconnect/Interface) bus via the bridge 205. Note that the host bus 204, the bridge 205, and the external bus 206 need not necessarily be provided separately, and the functions of such components can be implemented as a single bus.

The input device 208 includes an input means for a user to input information, such as a mouse, a keyboard, a touch panel, a button, a microphone, a switch, or a lever; an input control circuit that generates an input signal on the basis of the information input by the user and outputs the signal to the CPU 201; and the like. By operating the input device 208, a user of the portable terminal 20 is able to input various data to the portable terminal 20 and instruct the portable terminal 20 to perform a processing operation.

The output device 210 includes, for example, a display device such as a CRT (Cathode Ray Tube) display device, a liquid crystal display (LCD) device, an OLED (Organic Light Emitting Diode) device, or a lamp. Further, the output device 210 includes an audio output device such as a speaker or a headphone. The output device 210 outputs the played back content, for example. Specifically, the display device can display various information such as the played back image data using text or an image. Meanwhile, the audio output device converts the played back audio data into a sound and outputs the sound.

The storage device 211 is a device for storing data, constructed as an exemplary storage unit of the portable terminal 20 in accordance with this embodiment. The storage device 211 can include a non-transitory computer-readable storage medium, a recording device that records data on the storage medium, a reading device that reads data from the storage medium, a deleting device that deletes data recorded on the storage medium, and the like. The storage device 211 includes a HDD (Hard Disk Drive), as one example of a non-transitory computer-readable storage medium. This storage device 211 stores programs and various data that drive a hard disk and are executed by the CPU 201.

The drive 212 is a reader/writer for a storage medium, and is built in or externally attached to the portable terminal 20. The drive 212 reads out information recorded on a magnetic disk, an optical disc, or a magneto optical disk that is loaded or on a removable storage medium 25 such as semiconductor memory, and outputs the information to the RAM 203. In addition, the drive 212 can also write information to the removable storage medium 25.

The communication device 215 is a communication interface including a communication device and the like for connection to the communications network 12. The communication device 215 can be a communication device compatible with a wireless LAN (Local Area Network), a communication device compatible with a LTE (Long Term Evolution), or a wire communication device that performs wire communication.

### 2. First Embodiment

Described above with reference to FIGS. 1 to 3 is the basic configuration of the remote control system 1 that is common to the first embodiment to the third embodiment of the present disclosure. Next, the first embodiment of the present disclosure will be described in detail.

### 2-1. Functions of Portable Terminal and Server Device in Accordance with First Embodiment

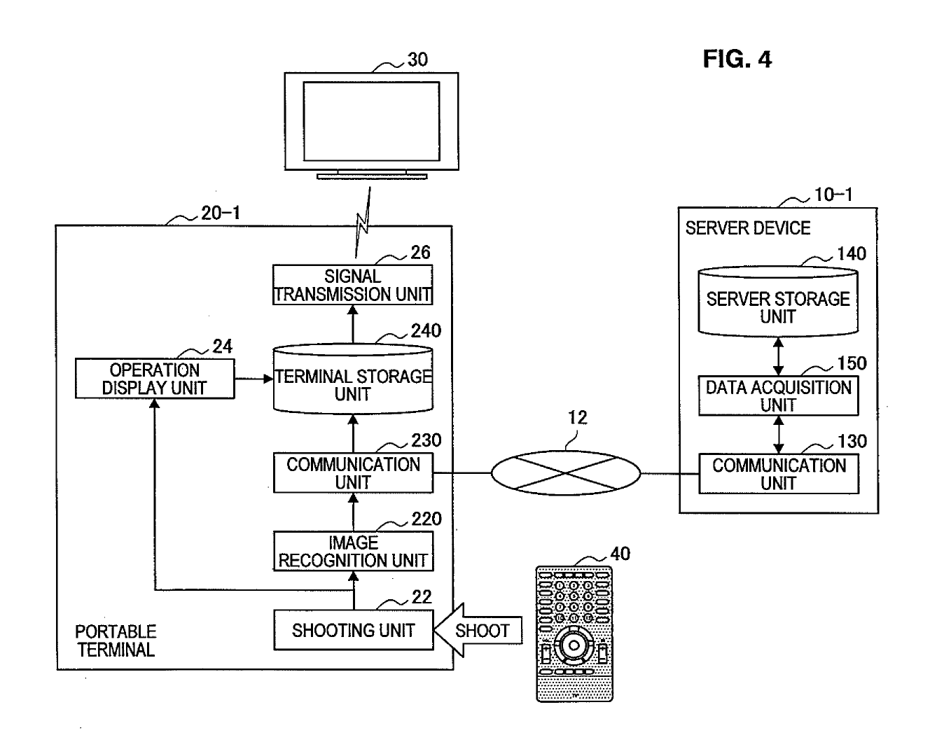

FIG. 4 is a functional block diagram showing the configurations of a portable terminal 20-1 and a server device 10-1 in accordance with the first embodiment. As shown in FIG. 4, the server device 10-1 in accordance with the first embodiment includes a communication unit 130, a non-transitory computer-readable server storage unit 140, and a data acquisition unit 150.

The communication unit 130 functions as a receiving unit that receives information from a device connected to the communications network 12 such as the portable terminal 20-1 and as a transmitting unit that transmits information to the device connected to the communications network 12. The communication unit 130 in accordance with this embodiment, for example, receives the recognized data of the remote commander 40 from the portable terminal 20-1, and transmits code data obtained by associating each operation button of the remote commander 40 with a signal code to the portable terminal 20-1.

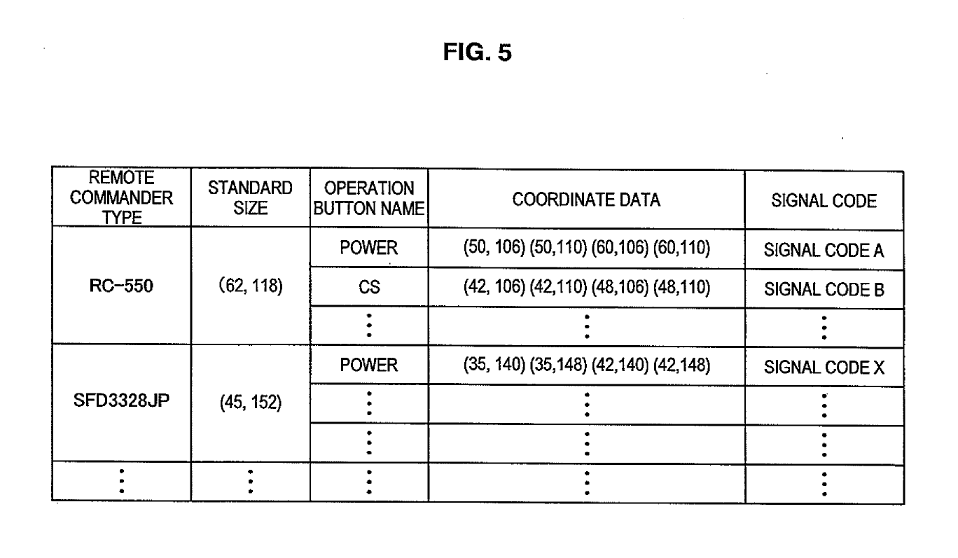

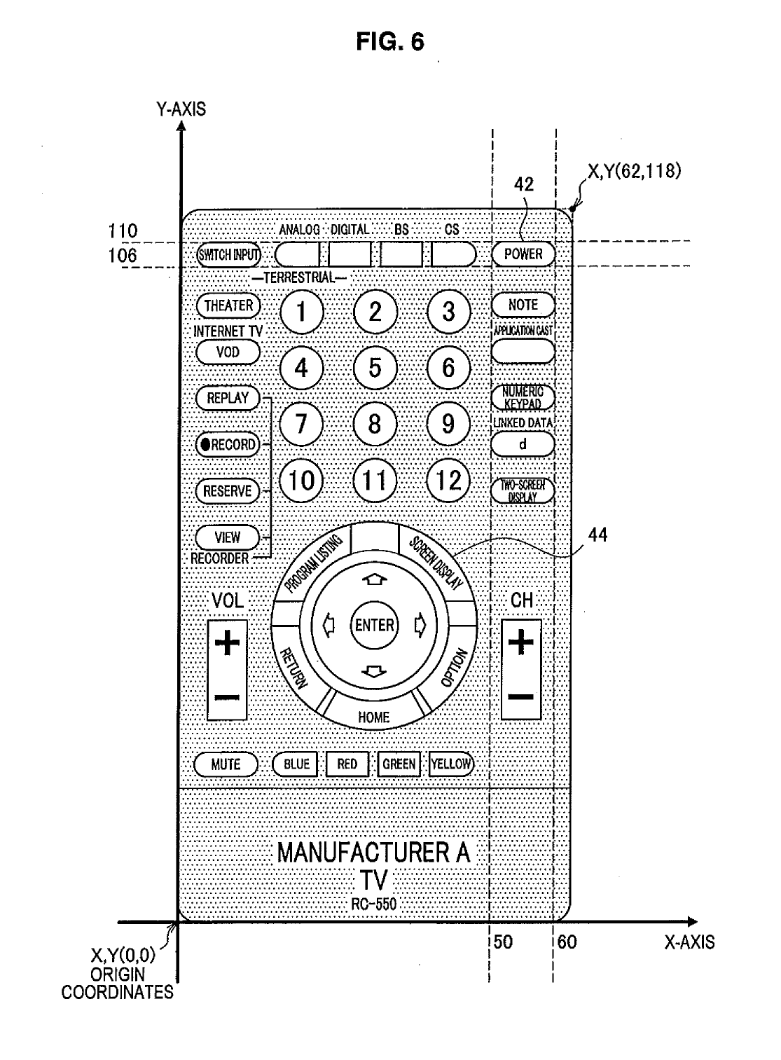

The server storage unit 140 stores, for various remote commanders, code data obtained by associating each button of each type of remote commander with a signal code. Hereinafter, the code data will be more specifically described with reference to FIGS. 5 and 6.

FIG. 5 is an explanatory diagram showing a specific example of the code data stored in the server storage unit 140. As shown in FIG. 5, the code data includes the remote commander type, standard size, operation button name, coordinate data, and signal code. In FIG. 5, “RC-550” and “SFD3328JP” are shown as examples of the remote commander type.

The standard size is information indicating the standard size of an image of a remote commander. For example, suppose that a remote commander of the type “RC-550” is displayed as shown in FIG. 6. Then, provided that the lower left vertex of the remote commander is at the origin coordinates (0,0), the standard size is represented by the coordinates (62,118) of the upper right vertex of the remote commander.

The operation button name is the name of each operation button such as “POWER” or “CS” as shown in FIG. 5, and is represented by the JIS code or the ASCII code, for example.

The coordinate data is data indicating a region of each operation button on an image of a remote commander. For example, the coordinate data can include a plurality of coordinate values, and a region surrounded by the plurality of coordinate values can represent a region of an operation button. As a specific example, when a display of each operation button is arranged as shown in FIG. 6, the coordinate data of an operation button “POWER” 42 can include four coordinate values: (50,106), (50,110), (60,106), and (60,110).

In regard to an operation button having a curved geometry like an operation button “HOME” 44 shown in FIG. 6, the operation button can be divided into a plurality of rectangular regions, and a set of coordinate values indicating the respective rectangular regions can be handled as the coordinate data.

The signal code is a code obtained by making the carrier frequency, signal transmission time, signal transmission pause time, or the like of a control signal to be transmitted into data.

The data acquisition unit 150, when the communication unit 130 has received the recognized data (type information) of the remote commander 40 from the portable terminal 20-1, acquires code data of the remote commander 40 from the server storage unit 140 on the basis of the recognized data. For example, when the communication unit 130 has received a type name “RC-550” as the recognized data of the remote commander 40, the data acquisition unit 150 acquires code data of “RC-550” from the server storage unit 140. The code data acquired by the data acquisition unit 150 is transmitted to the portable terminal 20-1 from the communication unit 130.

Meanwhile, as shown in FIG. 4, the portable terminal 20-1 in accordance with the first embodiment includes the shooting unit 22, the operation display unit 24, the signal transmission unit 26, an image recognition unit 220, a communication unit 230, and a terminal storage unit 240.

The shooting unit 22 is booted in response to a user operation, and shoots the remote commander 40. Note that the shooting unit 22 can shoot the remote commander 40 in the still image format or the moving image format.

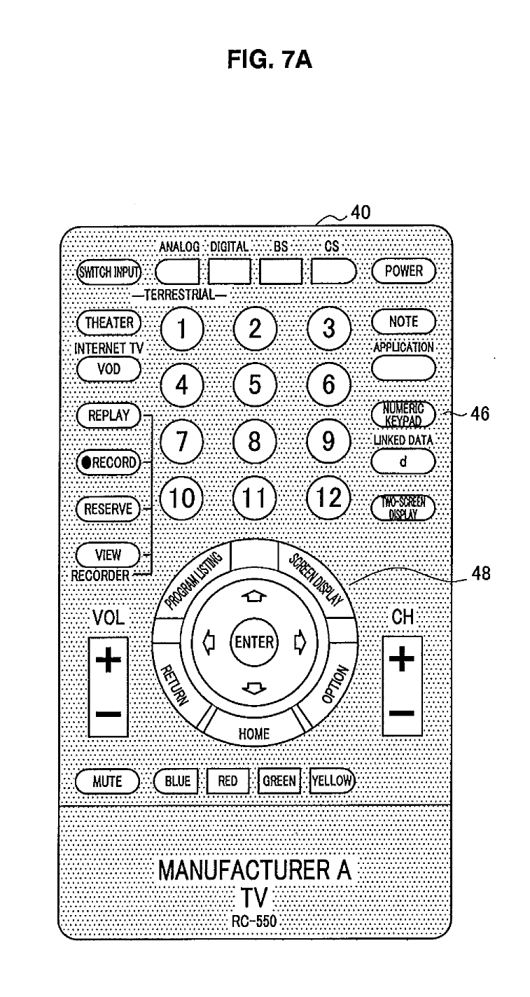

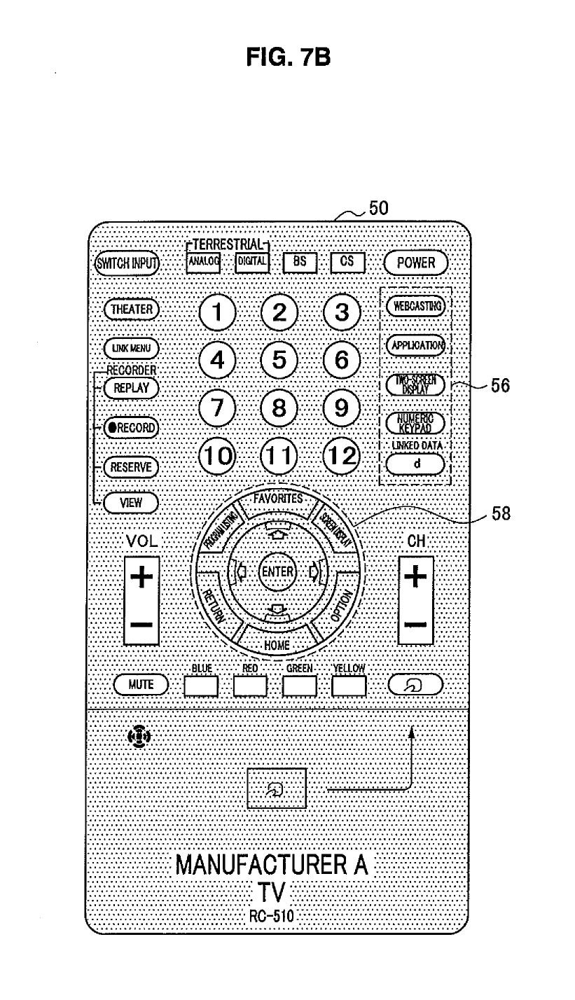

The image recognition unit 220 analyzes the image of the remote commander 40 shot by the shooting unit 22, and recognizes the type of the remote commander 40. For example, the remote commander 40 shown in FIG. 7A is similar in layout and exterior design to a remote commander 50 shown in FIG. 7B. However, a region 46 of the remote commander 40 and a region 56 of the remote commander 50, and a region 48 of the remote commander 40 and a region 58 of the remote commander 50 greatly differ in color and character. The image recognition unit 220 can recognize the type of the remote commander 40 on the basis of the characters and colors of such characteristic portions of the remote commander 40.

Note that if the image recognition unit 220 is able to recognize the character of the manufacturer name “MANUFACTURER A” or the model number “RC-550” at the bottom portion of the image of the remote commander 40, the image recognition unit 220 can recognize the type of the remote commander 40 on the basis of the manufacturer name or the model number. Meanwhile, when the shooting unit 22 shoots the remote commander 40 in the moving image format, shooting of the remote commander 40 by the shooting unit 22 can be continued until the type of the remote commander 40 is recognized by the image recognition unit 220. In addition, it is considered that a signal code corresponding to each operation button of remote commanders of the same manufacturer is identical. Thus, it may be sufficient to identify only the manufacturer as the type of the remote commander 40 in some cases.

Note that the image recognition unit 220 is not an essential component in the portable terminal 20-1 in accordance with this embodiment. When the portable terminal 20-1 does not have the image recognition unit 220, the portable terminal 20-1 can sequentially transmit images of the remote commander 40 shot by the shooting unit 22 to the server device 10-1 as the recognized data of the remote commander 40 so that the server device 10-1 can determine the type of the remote commander 40.

Although described above is an example in which the shot image of the remote commander 40 is used for the type recognition, the type recognition can also be performed on the basis of the shot image of the television device 30 that is remotely controlled by the remote commander 40. However, as there may be cases in which a frame portion, a playback device, and the like of the television device 30 may be built in furniture in some areas, it would be difficult to shoot each device in such cases. In addition, it has also been difficult to recognize a character such as a model number from the shot image of the television device 30 having a large screen of 40 inches or more, for example. From such viewpoint, it would be more effective to use the shot image of the remote commander 40 for the type recognition.

The communication unit 230 functions as a receiving unit that receives information from a device connected to the communications network 12 such as the server device 10-1 and as a transmitting unit that transmits information to the device connected to the communications network 12. For example, the communication unit 230 in accordance with this embodiment transmits the recognized data of the remote commander 40 obtained by the image recognition unit 220 to the server device 10-1, and receives code data of the remote commander 40 from the server device 10-1. Note that the communication unit 230 can have a 3G communication function, a Wi-Fi communication function, or the like.

The terminal storage unit 240 stores the code data received by the communication unit 230 from the server device 10-1. Such a terminal storage unit 240 can be a non-transitory computer-readable storage medium such as nonvolatile memory, a magnetic disk, an optical disc, or a MO (Magneto Optical) disk. Examples of the nonvolatile memory include EEPROM (Electrically Erasable Programmable Read-Only Memory) and EPROM (Erasable Programmable ROM). Examples of the magnetic disk include hard disks and disk-shaped magnetic bodies. Examples of the optical disc include CD (Compact Disc), DVD-R (Digital Versatile Disc Recordable), and BD (Blu-Ray Disc®).

The operation display unit 24 displays an image of the remote commander 40 shot by the imaging unit 22 as an operation display screen. Note that the operation display unit 24 can, when an image of the remote commander 40 is transmitted from the server device 10-1 together with the code data, display the image of the remote commander 40 received from the server device 10-1.

The signal transmission unit 26, when an operation button in the shot image of the remote commander 40 displayed on the operation display unit 24 is selected, transmits a control signal in accordance with a signal code corresponding to the selected operation button, on the basis of the code data stored in the terminal storage unit 240.

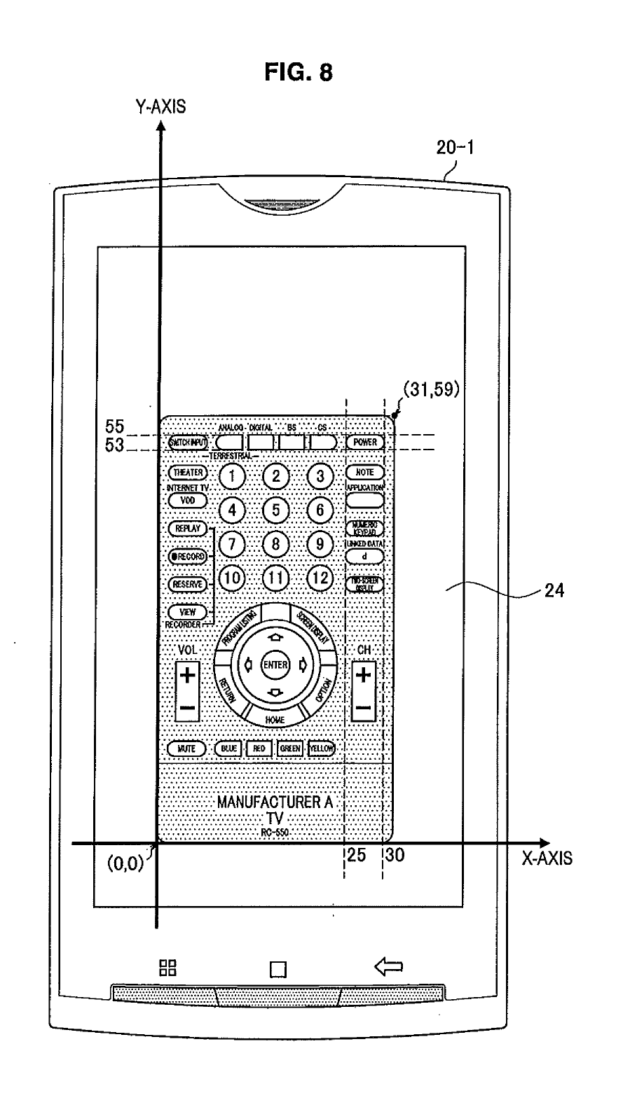

Note that when the size of the shot image of the remote commander 40 displayed on the operation display unit 24 is the same as the standard size of the remote commander 40, it is possible to determine an operation button selected by a user by using the coordinate data of each operation button received from the server device 10-1 as it is. Meanwhile, when the size of the shot image of the remote commander 40 differs from the standard size of the remote commander 40, it is possible to determine an operation button selected by a user by correcting the coordinate data of each operation button received from the server device 10-1 on the basis of the ratio of the two sizes. Hereinafter, such a point will be described more specifically with reference to FIG. 8.

FIG. 8 is an explanatory diagram showing a specific example of the shot image of the remote commander 40 displayed on the operation display unit 24. In the example of FIG. 8, provided that the coordinates of the lower left vertex of the shot image of the remote commander 40 are (0,0), the coordinates of the upper right vertex are (31,59). The coordinates (31,59) of the upper right vertex are a half the standard size (62,118) of “RC-550.”

Therefore, the portable terminal 20-1 uses a value, which is half the value of the coordinate data corresponding to each operation button included in the code data, as the coordinate data of each operation button in the shot image. For example, the portable terminal 20-1 can use four coordinate values: (25,53), (25,55), (30,53), and (30,55) as the coordinate data of the operation button “POWER,” and determine that the operation button “POWER” has been selected when a region surrounded by the four coordinate values is touched.

Note that when the shot image of the remote commander 40 has keystone distortion, the portable terminal 20-1 can apply keystone correction to the coordinate data of each operation button received from the server device 10-1, and use the corrected coordinate data. According to such a configuration, it is possible to improve the accuracy of determination of an operation button selected by a user.

In addition, the portable terminal 20-1 can, when an operation button is selected by a user, execute one or more actions upon selection, such as outputting a sound, changing the color of the selected operation button, and changing the stereoscopic representation of the selected operation button using recesses or projections.

As described above, the remote control system 1 in accordance with the first embodiment of the present disclosure can recognize the type of the remote commander 40 on the basis of the shot image of the remote commander 40, display the shot image of the remote commander 40 as an operation display screen on the portable terminal 20-1, and transmitting from the portable terminal 20-1 a control signal corresponding to an operation button selected by a user on the operation display screen.

### 2-2. Operations of Portable Terminal and Server Device in Accordance with First Embodiment

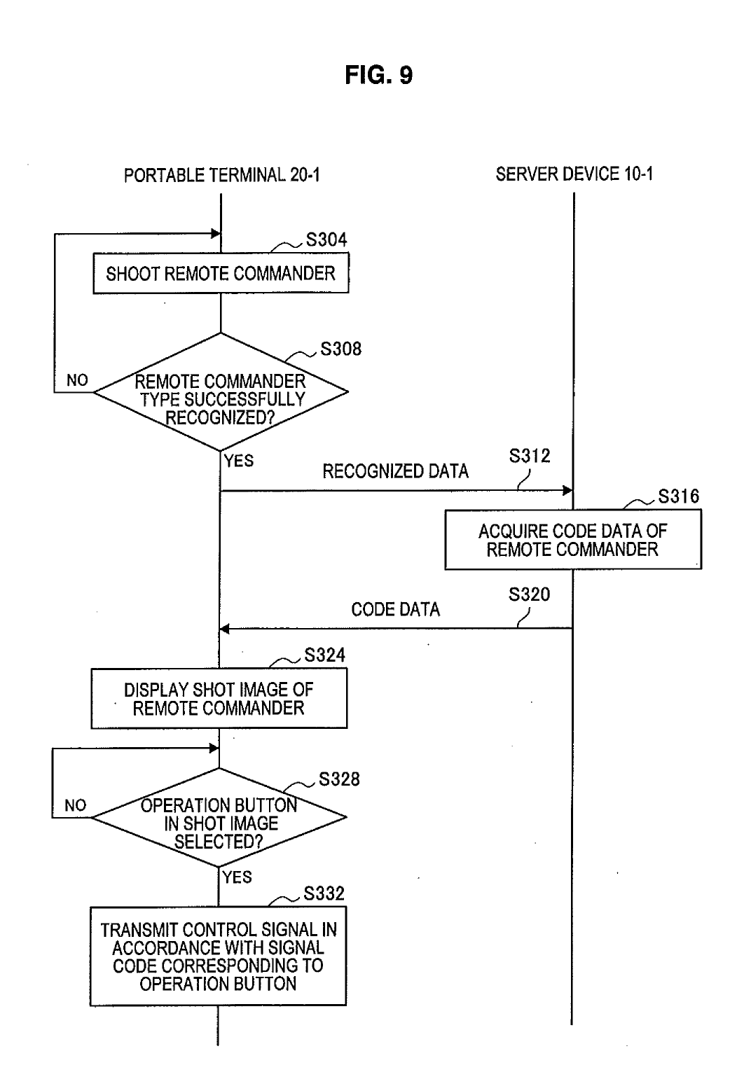

Next, the operations of the portable terminal 20-1 and the server device 10-1 in accordance with the first embodiment will be described with reference to FIG. 9.

FIG. 9 is a sequence diagram showing the operations of the portable terminal 20-1 and the server device 10-1 in accordance with the first embodiment. As shown in FIG. 9, first, the shooting unit 22 of the portable terminal 20-1 shoots the remote commander 40 in accordance with an instruction of a user (e.g., an instruction for starting an application in accordance with this embodiment) (S304).

Thereafter, when the type of the remote commander 40 is recognized by the image recognition unit 220 of the portable terminal 20-1 on the basis of the shot image of the remote commander 40 (S308/yes), the communication unit 230 of the portable terminal 20-1 transmits the recognized data of the remote commander 40 to the server device 10-1 (S312). Meanwhile, when the type of the remote commander 40 is not recognized by the image recognition unit 220 (S308/no), the process from S304 is repeated.

The data acquisition unit 150 of the server device 10-1, when the communication unit 130 has received the recognized data of the remote commander 40 from the portable terminal 20-1, acquires the code data of the remote commander 40 from the server storage unit 140 (S316). Next, the communication unit 130 of the server device 10-1 transmits the code data acquired by the data acquisition unit 150 to the portable terminal 20-1 (S320).

Then, the portable terminal 20-1, upon receiving the code data of the remote commander 40 from the server device 10-1, displays the shot image of the remote commander 40 obtained by the shooting unit 22 on the operation display unit 24 (S324). Thereafter, when an operation button in the shot image of the remote commander 40 is selected by the user (S328), the signal transmission unit 26 transmits a control signal in accordance with a signal code corresponding to the selected operation button (S332).

Accordingly, it becomes possible for the television device 30, which is an exemplary user device to be remotely controlled, to operate in accordance with the control signal transmitted from the portable terminal 20-1.

### 3. Second Embodiment

The first embodiment of the present disclosure has been described above. Next, the second embodiment of the present disclosure will be described. A server device 10-2 in accordance with the second embodiment can provide as an operation display screen a GUI with a different level of simplicity according to a portable terminal 20-2, together with code data, to the portable terminal 20-2.

### 3-1. Functions of Portable Terminal and Server Device in Accordance with Second Embodiment

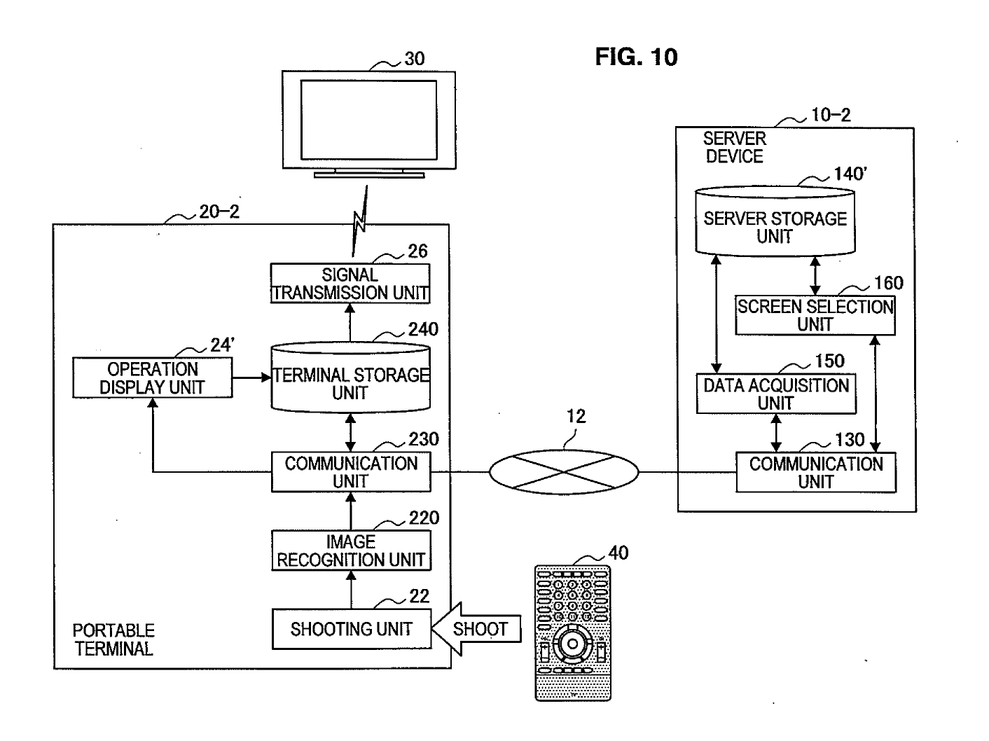

FIG. 10 is a functional block diagram showing the configurations of the portable terminal 20-2 and the server device 10-2 in accordance with the second embodiment. As shown in FIG. 10, the server device 10-2 in accordance with the second embodiment includes a communication unit 130, a server storage unit 140′, a data acquisition unit 150, and a screen selection unit 160.

The server storage unit 140′ stores a plurality of types of GUIs with different levels of simplicity as an operation display screen for each type of remote commander. For example, the server storage unit 140′ stores the original version GUI such as a shot image of a remote commander or a diagram image obtained by processing the shot image, and a simplified version GUI that is simpler than the original version GUI.

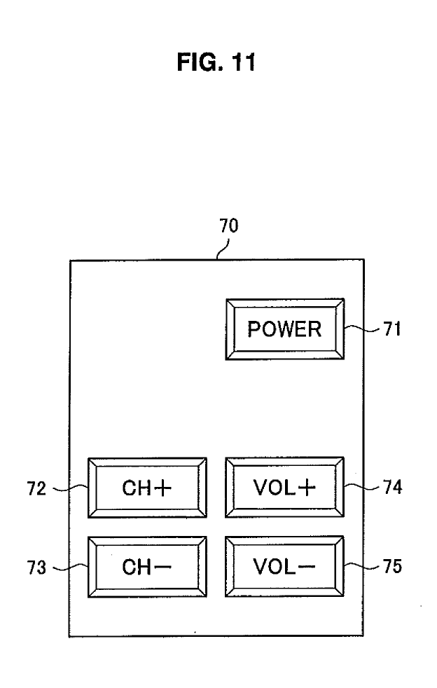

FIG. 11 is an explanatory diagram showing a specific example of a simplified version GUI 70. As shown in FIG. 11, the simplified version GUI 70 includes operation buttons “POWER” 71, “CH+” 72, “CH−” 73, “VOL+” 74, and “VOL−” 75. As described above, the simplified version GUI 70 has less types of and a less number of operation buttons arranged thereon than the original version GUI. Thus, the simplified version GUI 70 is a GUI that is suited for users who are not used to the operation, and for portable terminals with touch panels on which exacting operations are difficult to perform. Note that it is possible to use a common GUI as the simplified version GUIs 70 of a plurality of types of remote commanders.

The server storage unit 140′ stores code data obtained by associating each operation button of each type of remote commander with a signal code as in the first embodiment. However, unlike in the first embodiment, the server storage unit 140′ stores code data of each remote commander for both the simplified version GUI and the original version GUI.

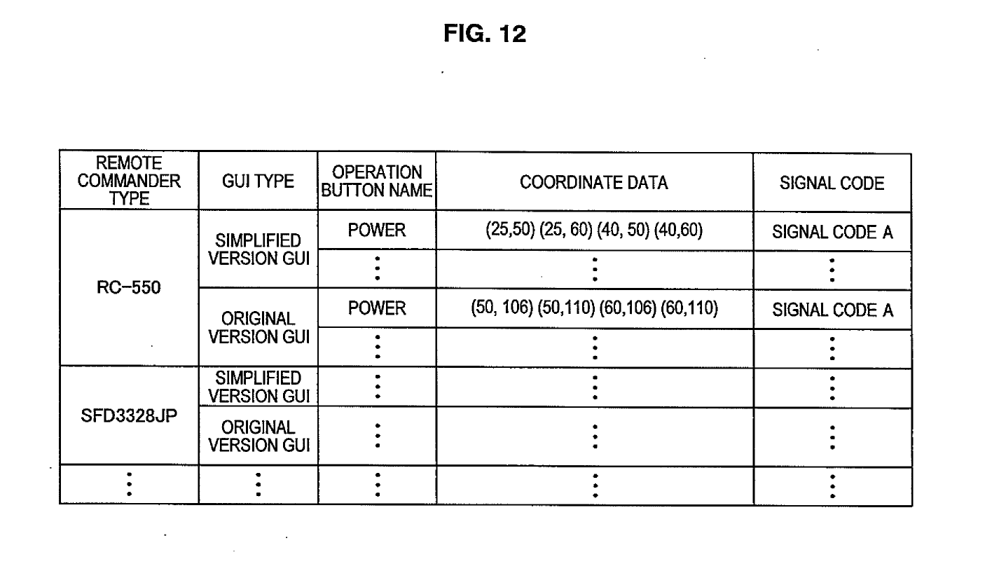

FIG. 12 is an explanatory diagram showing a specific example of the code data in accordance with the second embodiment. As shown in FIG. 12, the server storage unit 140′ stores code data of each remote commander for each of GUIs with different levels of simplicity. For example, in regard to a single type of remote commander “RC-550,” the server storage unit 140′ stores code data corresponding to the simplified version GUI and code data corresponding to the original version GUI.

Note that the code data includes the operation button name, coordinate data, and signal code as described in the first embodiment. As shown in FIG. 12, for example, a signal code of the operation button “POWER” is common to the simplified version GUI and the original version GUI. However, as the display content of the simplified version GUI differs from that of the original version GUI, the coordinate data of each operation button of the simplified version GUI also differs from that of the original version GUI.

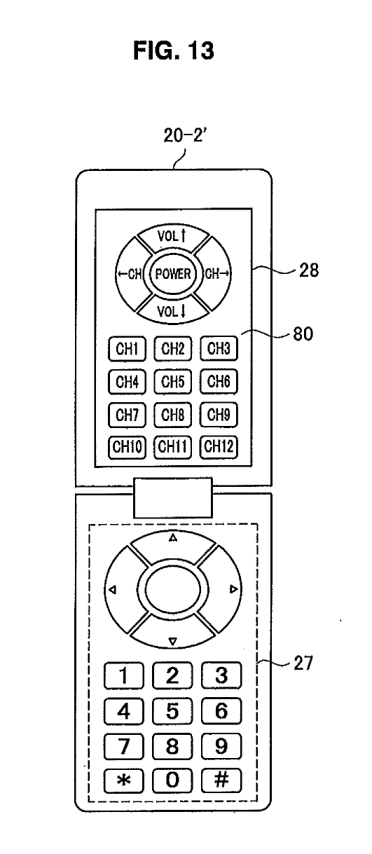

Although described above is the simplified version GUI 70 that is presumed to be displayed on the portable terminal 20-2 with a touch panel, the configuration of the simplified version GUI is not limited to the example shown in FIG. 11. Hereinafter, a variation of the simplified version GUI will be described with reference to FIG. 13.

FIG. 13 is an explanatory diagram showing a specific example of another simplified version GUI 80. The simplified version GUI 80 is a GUI that is presumed to be displayed on a portable terminal 20-2′ having a display area 28 and an operation area 27 that are provided separately. FIG. 13 shows a state in which the simplified version GUI 80 is displayed on the portable terminal 20-2′.

As shown in FIG. 13, the simplified version GUI 80 is a GUI that mimics the arrangement of buttons in the operation area 27 of the portable terminal 20-2′. According to such a simplified version GUI 80, a user is able to select a button by pressing an operation button in the operation area 27. Note that it is possible to associate the identifier of each operation button in the operation area 27, as the coordinate data, with the code data of the simplified version GUI 80.

Referring again to the configuration of the server device 10-2 shown in FIG. 10, the communication unit 130 receives, in addition to the recognized data of the remote commander 40, terminal information of the portable terminal 20-2 from the portable terminal 20-2. Herein, examples of the terminal information of the portable terminal 20-2 include the terminal type of the portable terminal 20-2, attribute information (e.g., age or sex) of a user of the portable terminal 20-2, and information indicating the level of simplicity of a GUI that has been previously used as an operation display screen on the portable terminal 20-2.

The screen selection unit 160, on the basis of the recognized data and the terminal information received by the communication unit 130, selects a GUI to be transmitted to the portable terminal 20-2 from the server storage unit 140′. Specifically, the screen selection unit 160 selects a GUI corresponding to the terminal information among GUIs that are associated with the type of remote commander indicated by the recognized data.

For example, when the terminal information indicates the terminal type of the portable terminal 20-2, and the terminal type is a terminal with simplified operability and functionality types for those who are not used to the operation, the screen selection unit 160 can select the simplified version GUI. Meanwhile, when the terminal type is an ordinary terminal or a highly functional terminal, the screen selection unit 160 can select the original version GUI. Further, the screen selection unit 160 can, when the terminal type is an old terminal, select the simplified version GUI, and can, when the terminal type is a new terminal, select the original version GUI.

When the terminal information indicates the attributes such as the age of a user of the portable terminal 20-2 and the user is at a young age (e.g., those under or of elementary school age) or at an old age, the screen selection unit 160 can select the simplified version GUI. Meanwhile, when the user is neither at a young age nor an old age, the screen selection unit 160 can select the original version GUI.

When the terminal information indicates a GUI that has been previously used on the portable terminal 20-2, the screen selection unit 160 can select the GUI indicated by the terminal information. For example, the screen selection unit 160 can, when the terminal information indicates the simplified version GUI, select the simplified version GUI, and can, when the terminal information indicates the original version GUI, select the original version GUI.

The data acquisition unit 150 acquires from the server storage unit 140′ code data corresponding to the GUI of the remote commander selected by the screen selection unit 160. Then, the communication unit 130 transmits to the portable terminal 20-2 the GUI selected by the screen selection unit 160 and the code data acquired by the data acquisition unit 150.

Note that the server device 10-2 can enlarge/shrink the GUI selected by the screen selection unit 160 so that it matches the size of the operation display unit 24′ of the portable terminal 20-2, and transmit it to the portable terminal 20-2. In such a case, the server device 10-2 can correct the coordinate data included in the code data in accordance with the enlargement ratio/reduction ratio of the GUI. Likewise, the server device 10-2 can correct the GUI selected by the screen selection unit 160 in accordance with the resolution of the portable terminal 20-2 and transmit it to the portable terminal 20-2.

In addition, the server device 10-2 can, when a GUI is specified by or a change is requested by the portable terminal 20-2, transmit the specified or requested GUI as well as code data corresponding to the GUI. Alternatively, the server device 10-2 can switch the GUI on the portable terminal 20-2 on an as needed basis by transmitting in advance to the portable terminal 20-2 all GUIs and code data corresponding to all the GUIs.

Although two types of GUIs including the simplified version GUI and the original version GUI are given as examples of the GUIs with different levels of simplicity above, the types of the GUIs can be more than two. For example, GUIs with different levels of simplicity can include, in addition to the simplified version GUI and the original version GUI, a normal version GUI, a high-spec GUI, or a GUI for women.

Meanwhile, the portable terminal 20-2 in accordance with the second embodiment includes, as show in FIG. 10, the shooting unit 22, the operation display unit 24′, the signal transmission unit 26, the image recognition unit 220, the communication unit 230, and the terminal storage unit 240. As the functions of the shooting unit 22 and the image recognition unit 220 have been described in the first embodiment, detailed description thereof will be omitted.

The communication unit 230 transmits the recognized data of the remote commander 40 obtained by the image recognition unit 220 and the terminal information of the portable terminal 20-2 to the server device 10-2. In addition, the communication unit 230 receives a GUI and code data transmitted from the server device 10-2. The code data received by the communication unit 230 is stored into the terminal storage unit 240.

The operation display unit 24′ displays the GUI received by the communication unit 230 as an operation display screen. The signal transmission unit 26, when an operation button in the GUI displayed on the operation display unit 24 is selected, transmits a control signal in accordance with a signal code corresponding to the selected operation button, on the basis of the code data stored in the terminal storage unit 240.

Note that a user is able to change the GUI by operating the operation display unit 24′, for example. For example, when another GUI is stored in the terminal storage unit 240, the operation display unit 24′ can read such another GUI from the terminal storage unit 240 and display it. Meanwhile, when another GUI is not stored in the terminal storage unit 240, the communication unit 230 can request the server device 10-2 to transmit another GUI.

A GUI and code data received from the server device 10-2 can be shared among, for example, family members through data transfer on a network or via memory cards. In addition, when a GUI and code data are saved in a memory card, it becomes possible for the GUI and the code data to be, when a new terminal is purchased to replace the portable terminal 20-2, used on the new terminal without the need to access the server device 10-2.

### 3-2. Operations of Portable Terminal and Server Device in Accordance with Second Embodiment

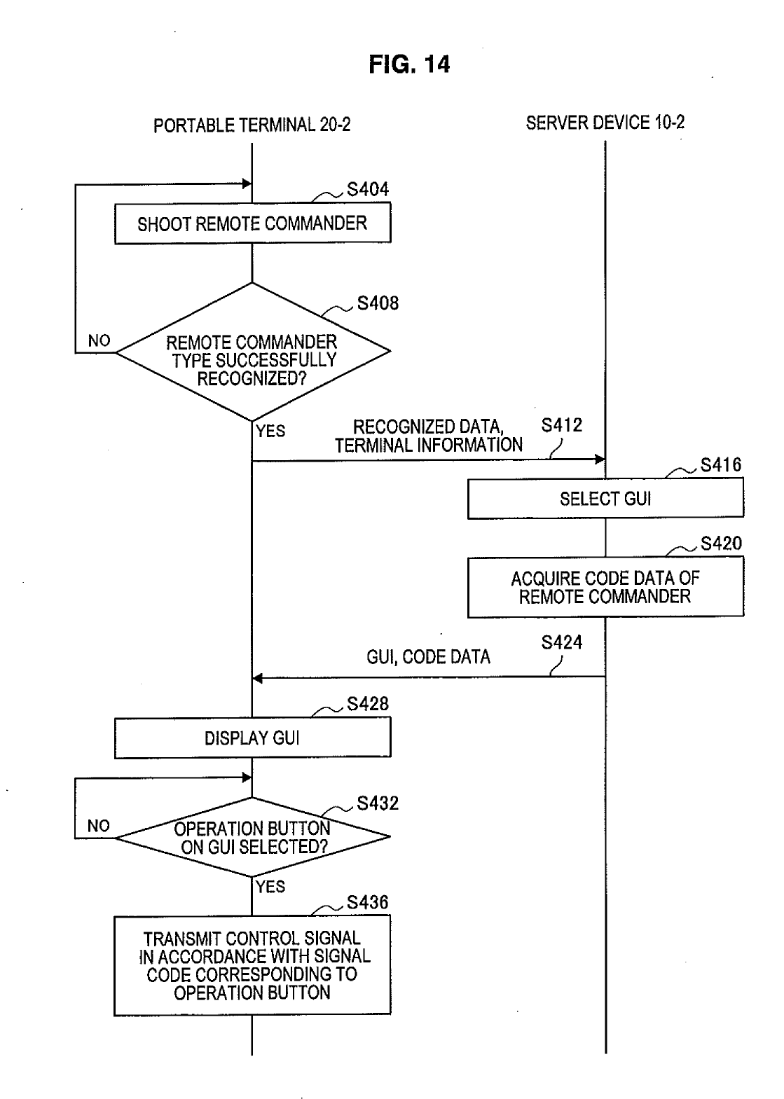

The configurations of the portable terminal 20-2 and the server device 10-2 in accordance with the second embodiment of the present disclosure have been described above. Next, the operations of the portable terminal 20-2 and the server device 10-2 in accordance with the second embodiment of the present disclosure will be described with reference to FIG. 14.

FIG. 14 is a sequence diagram showing the operations of the portable terminal 20-2 and the server device 10-2 in accordance with the second embodiment. As shown in FIG. 14, first, the shooting unit 22 of the portable terminal 20-2 shoots the remote commander 40 in accordance with an instruction of a user (e.g., an instruction for starting an application in accordance with this embodiment) (S404).

Thereafter, when the type of the remote commander 40 is recognized by the image recognition unit 220 of the portable terminal 20-2 on the basis of the shot image of the remote commander 40 (S408/yes), the communication unit 230 of the portable terminal 20-2 transmits the recognized data of the remote commander 40 and the terminal information of the portable terminal 20-2 to the server device 10-2 (S412). Meanwhile, when the type of the remote commander 40 is not recognized by the image recognition unit 220 (S408/no), the process from S404 is repeated.

The screen selection unit 160 of the server device 10-2, when the communication unit 130 has received the terminal information and the recognized data of the remote commander 40 from the portable terminal 20-2, selects a GUI corresponding to the terminal information from among GUIs that are associated with the type of remote commander indicated by the recognized data (S416).

Further, the data acquisition unit 150 of the server device 10-2 acquires from the server storage unit 140′ code data corresponding to the GUI of the remote commander selected by the screen selection unit 160 (S420). Then, the communication unit 130 transmits to the portable terminal 20-2 the GUI selected by the screen selection unit 160 and the code data acquired by the data acquisition unit 150 (S424).

Then, the portable terminal 20-2, upon receiving the GUI and the code data of the remote commander 40 from the server device 10-2, displays the received GUI as an operation display screen on the operation display unit 24′ (S428). Thereafter, when an operation button on the GUI is selected by a user (S432), the signal transmission unit 26 transmits a control signal in accordance with a signal code corresponding to the selected operation button (S436).

As described above, according to the second embodiment of the present disclosure, it is possible to provide, together with code data, a GUI with a different level of simplicity according to the portable terminal 20-2 as an operation display screen. Thus, it becomes possible for the portable terminal 20-2 to display a user-friendly operation display screen.

### 4. Third Embodiment

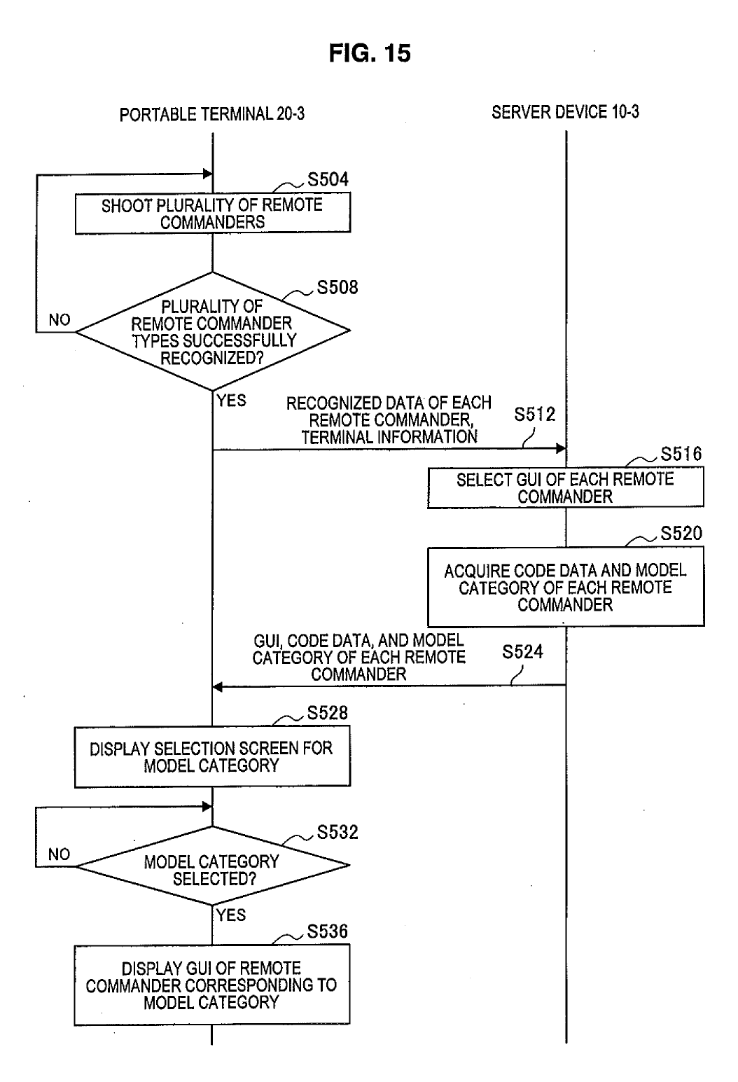

Next, the third embodiment of the present disclosure will be described. A portable terminal 20-3 in accordance with the third embodiment of the present disclosure can selectively implement the functions of different remote commanders 40. Hereinafter, detailed description thereof will be given with reference to FIGS. 15 to 17. Note that the portable terminal 20-3 and a server device 10-3 in accordance with the third embodiment each have the functional blocks described in the second embodiment.

FIG. 15 is an explanatory diagram showing the operations of the portable terminal 20-3 and the server device 10-3 in accordance with the third embodiment. As shown in FIG. 15, first, the shooting unit 22 of the portable terminal 20-3 shoots a plurality of remote commanders 40 in accordance with an instruction of a user (e.g., an instruction for starting an application in accordance with this embodiment) (S504).

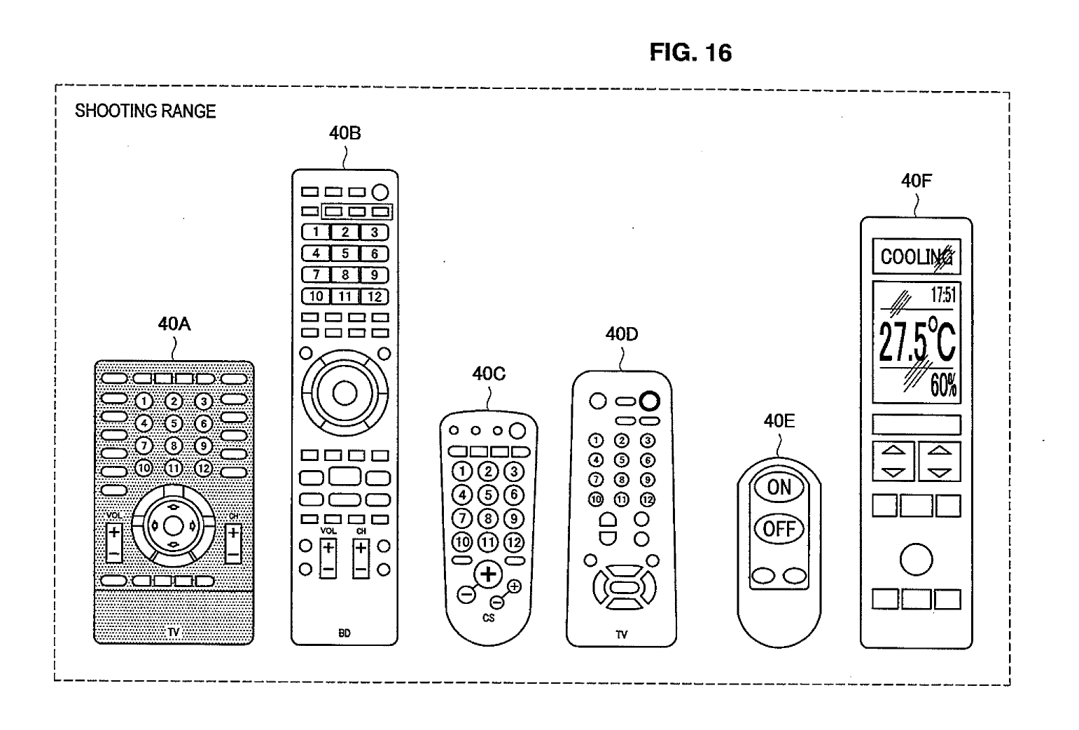

FIG. 16 is an explanatory diagram showing an exemplary range of remote commanders 40 shot by the portable terminal 20-3. As shown in FIG. 16, the portable terminal 20-3 concurrently shoots a plurality of remote commanders 40 using the shooting unit 22. For example, the portable terminal 20-3 concurrently shoots a remote commander 40A for a television device, a remote commander 40B for a BD (Blu-Ray Disc®) playback device, a remote commander 40C for a DVD playback device, a remote commander 40D for a CS, a remote commander 40E for lighting, and a remote commander 40F for an air conditioner, as shown in FIG. 16. Note that the portable terminal 20-3 can also sequentially shoot the plurality of remote commanders 40 individually.

Thereafter, when the types of the plurality of remote commanders 40 are recognized by the image recognition unit 220 of the portable terminal 20-3 on the basis of the shot image of the remote commanders 40 (S508/yes), the communication unit 230 of the portable terminal 20-3 transmits the recognized data of each remote commander 40 and the terminal information of the portable terminal 20-3 to the server device 10-3 (S512).

The screen selection unit 160 of the server device 10-3, when the communication unit 130 has received the terminal information and the recognized data of each remote commander 40 from the portable terminal 20-3, selects a GUI corresponding to the terminal information among GUIs that are associated with the type of each remote commander indicated by the recognized data (S516).

Further, the data acquisition unit 150 of the server device 10-3 acquires from the server storage unit 140′ code data corresponding to the GUI of each remote commander selected by the screen selection unit 160 (S520). Then, the communication unit 130 transmits to the portable terminal 20-3 each GUI selected by the screen selection unit 160 and each code data acquired by the data acquisition unit 150 (S524).

Then, the portable terminal 20-3, upon receiving the GUI and the code data of each remote commander 40 from the server device 10-3, displays a selection screen for a model category (S528).

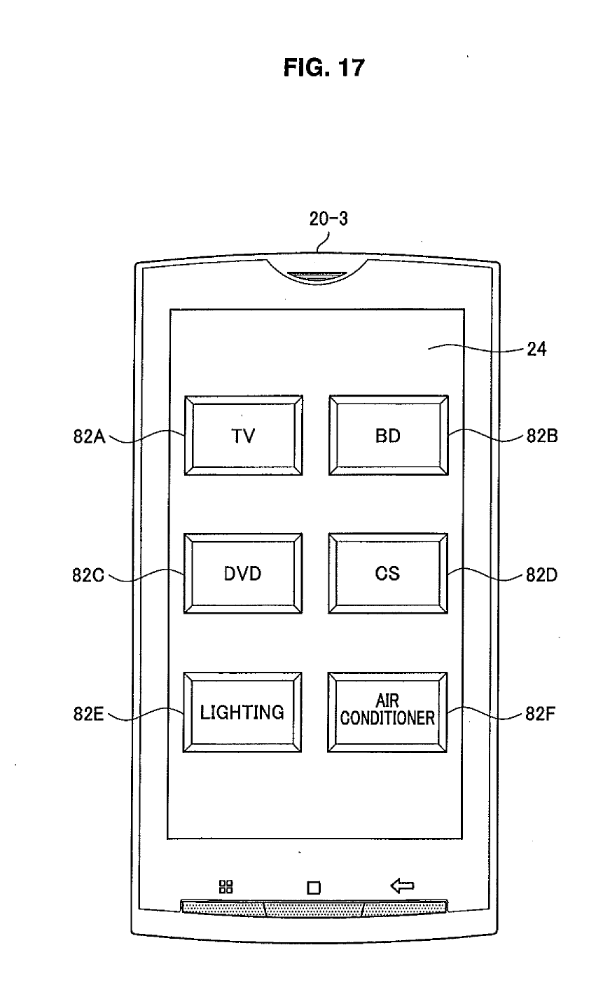

FIG. 17 is an explanatory diagram showing a specific example of a selection screen for a model category. As shown in FIG. 17, the selection screen for a model category includes a selection button 82A for a GUI of a television device, a selection button 82B for a GUI of a BD (Blu-Ray Disc®) playback device, a selection button 82C for a GUI of a DVD playback device, a selection button 82D for a GUI of a CS, a selection button 82E for a GUI of lighting, and a selection button 82F for a GUI of an air conditioner. The selection screen for a model category is not limited to the example shown in FIG. 17, and can be represented by, for example, icons, photographs of the models of the main bodies, or the model names of the main bodies.

The portable terminal 20-3, when a model category is selected by a user on such a selection screen for a model category, displays a GUI of the remote commander 40 corresponding to the selected model category (S536).

It is predicted that the original version GUI of each remote commander 40 may lack in design consistency. Thus, the server device 10-3 can provide GUIs with uniform design tastes (e.g., button shape and tint).

### 5. Fourth Embodiment

The third embodiment of the present disclosure has been described above. Next, the fourth embodiment of the present disclosure will be described. A portable terminal 20-4 in accordance with the fourth embodiment of the present disclosure can obtain equivalent effects to those of the first to third embodiments even when the portable terminal 20-4 does not have a shooting function.

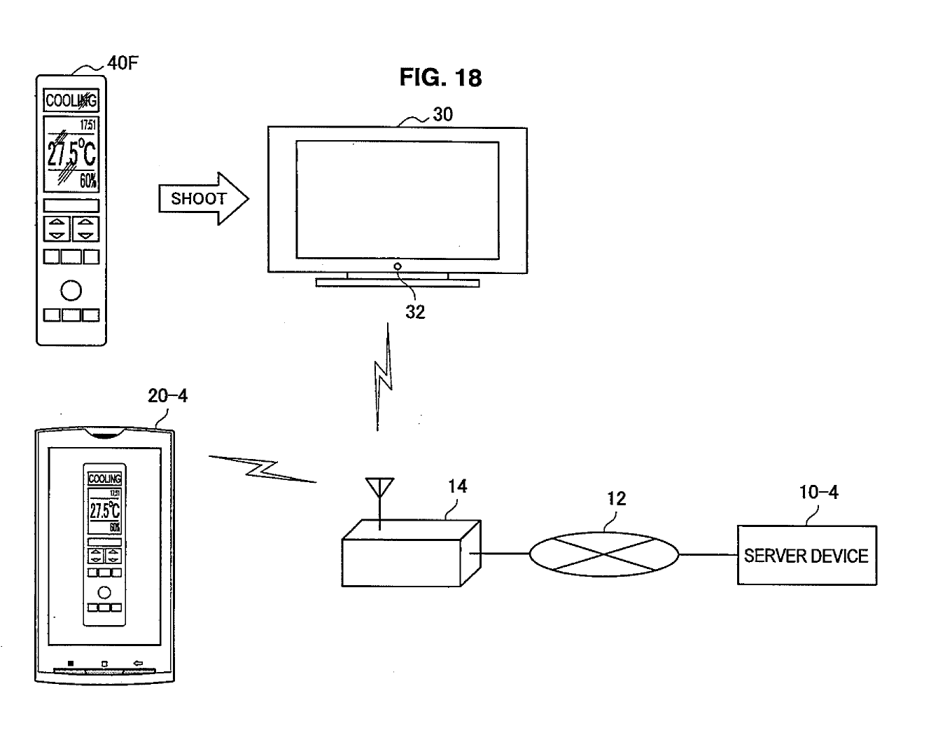

FIG. 18 is an explanatory diagram showing the configuration of a remote control system in accordance with the fourth embodiment of the present disclosure. As shown in FIG. 18, the remote control system in accordance with the fourth embodiment includes a server device 10-4, a communications network 12, a Wi-Fi access point 14, a portable terminal 20-4, a television device 30, and a remote commander 40F.

The portable terminal 20-4 and the television device 30 are wirelessly connected via the Wi-Fi access point 14. In addition, the television device 30 has a shooting unit 32, whereas the portable terminal 20-4 does not have a shooting function.

In such a remote control system in accordance with the fourth embodiment, the portable terminal 20-4 switches the shooting unit 32 of the television device 30 into a shooting mode using an application in accordance with this embodiment. Specifically, the portable terminal 20-4 transmits an instruction to the television device 30 to start shooting via the Wi-Fi access point 14. Note that a user can also switch the shooting unit 32 into a shooting mode by directly operating the television device 30.

Then, when the user passes the remote commander 40F in front of the television device 30, a shot image of the remote commander 40F is recognized by the television device 30, and the recognized data of the remote commander 40F is transmitted from the television device 30 to the server device 10-4.

Next, the server device 10-4 acquires code data of the remote commander 40F on the basis of the recognized data, and transmits the code data to the portable terminal 20-4 via the Wi-Fi access point 14. Note that when the server device 10-4 is able to grasp the terminal information of the portable terminal 20-4, the server device 10-4 can select a GUI in accordance with the terminal information and transmit it to the portable terminal 20-4 as described in the second embodiment.

According to the aforementioned configuration, it becomes possible for the portable terminal 20-4 to display a shot image or a GUI of the remote commander 40F and to transmit a control signal corresponding to an operation button selected by a user.

### 6. Conclusion

As described above, according to the remote control system 1 in accordance with the first embodiment of the present disclosure, it is possible to recognize the type of the remote commander 40 on the basis of a shot image of the remote commander 40, display the shot image of the remote commander 40 as an operation display screen on the portable terminal 20-1, and transmit a control signal corresponding to an operation button selected by a user on the operation display screen.

In addition, according to the second embodiment of the present disclosure, it is possible to provide, together with code data, a GUI with a different level of simplicity according to the portable terminal 20-2 as an operation display screen. Thus, it becomes possible for the portable terminal 20-2 to display a user-friendly operation display screen.

Further, according to the third embodiment of the present disclosure, it is possible to selectively implement the functions of different remote commanders 40 on the portable terminal 20-3. Furthermore, according to the fourth embodiment of the present disclosure, it is possible to obtain equivalent effects to those of the first to third embodiments even when the portable terminal 20-4 is not provided with a shooting function.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

For example, code data and GUIs stored in the server device 10 can be uploaded by an operator of the server device 10 or be uploaded by an end user. In such a case, it is possible to add an identifier, which indicates whether or not each code data or GUI has been uploaded by an operator of the server device 10, to each code data and GUI.

In addition, the steps in the processes of the portable terminal 20 and the server device 10 in this specification need not necessarily be processed in a time-series order in accordance with the order described in the flowchart. For example, the steps in the processes of the portable terminal 20 and the server device 10 can be performed in an order different from that described in the flowchart, or be processed in parallel.

It is also possible to create a computer program for causing built-in hardware, such as a dedicated CPU or other dedicated or general purpose processor, ROM, and RAM, in the portable terminal 20 and the server device 10 to exert a function that is equivalent to each of the aforementioned configurations of the portable terminal 20 and the server device 10. In addition, a non-transitory computer-readable storage medium for storing the computer program executable by the processor is also provided.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An operational terminal comprising:
a processor configured so as to:
transmit operational terminal information regarding the operational terminal and type information of a remote commander;
receive display information for displaying one or more operational elements associated with the remote commander and signal code information respectively corresponding to each of the one or more operational elements, the display information being based on the operational terminal information and the type information;
display, based on the display information, the one or more operational elements for selection by a user on a display screen; and,
transmit, based on the selection of a particular one of the one or more operational elements displayed on the display screen, a control signal for controlling an operation of a device, the control signal being transmitted in accordance with the signal code information respectively corresponding to the selected particular one of the one or more operational elements.

2. The operational terminal of claim 1, wherein processor is further configured to determine the type information of the remote commander based on an analysis of an image of the remote commander.

3. The operational terminal of claim 2, wherein the image of the remote commander includes information regarding the one or more operational elements associated with the remote commander.

4. The operational terminal of claim 2, wherein the operation terminal further comprises a shooting unit for capturing the image of the remote commander.

5. The operational terminal of claim 1, wherein the operational terminal information regarding the operational terminal includes information regarding a display unit associated with the operational terminal.

6. The operational terminal of claim 1, wherein the operational terminal further comprises a display unit, and the processor is further configured to display the display screen on the display unit.

7. The operational terminal of claim 6, wherein the display screen is displayed on a touch panel of the display unit.

8. The operational terminal of claim 1, wherein the operational terminal further comprises one or more buttons for the selection of the one of the one or more operational elements displayed on the display screen.

9. The operational terminal of claim 1, wherein the operational terminal further comprises a microphone, and the processor is further configured to receive the selection of the particular one of the one of the one or more operational elements displayed on the display screen by performing speech processing on speech captured by the microphone.

10. The operational terminal of claim 1, wherein the operational terminal is configured as a personal computer, a phone, an electronic notebook, a tablet, a media device, a remote control, or a gaming machine.

11. A server comprising:
a processor configured so as to:
receive operational terminal information of an operational terminal and type information of a remote commander;
acquire, based on the type information of the remote commander, signal code information respectively corresponding to each of one or more operational elements associated with the remote commander;
determine, based on the operational terminal information, display information for displaying the one or more operational elements associated with the remote commander; and,
transmit the display information and the signal code information respectively corresponding to each of the one or more operational elements.

12. The server of claim 11, wherein the operational terminal information received by the server includes information regarding a size of a display screen, and the processor is further configured to determine the display information based on the size of the display screen.

13. The server of claim 11, wherein the display information transmitted by the server includes coordinate data for displaying the one or more operational elements on the display screen.

14. The server of claim 11, wherein the display information transmitted by the server includes a simplified GUI image of the remote commander.

15. The server of claim 11, wherein the type information received by the server includes an image of the remote commander.

16. The server of claim 11, wherein the type information received by the server includes model information and/or manufacturer information of the remote commander.

17. A method for operating an operational terminal, the method comprising:
transmitting operational terminal information regarding the operational terminal and type information of a remote commander;
receiving display information for displaying one or more operational elements associated with the remote commander and signal code information respectively corresponding to each of the one or more operational elements, the display information being based on the operational terminal information and the type information;
displaying, using a processor and based on the display information, the one or more operational elements for selection by a user on a display screen; and,
transmitting, based on the selection of a particular one of the one or more operational elements displayed on the display screen, a control signal for controlling an operation of a device, the control signal being transmitted in accordance with the signal code information respectively corresponding to the selected particular one of the one or more operational elements.

18. A non-transitory computer-readable medium storing computer executable instructions of a program, the instructions, when executed by a control unit, configuring the control unit to:
transmit operational terminal information regarding the operational terminal and type information of a remote commander;
receive display information for displaying one or more operational elements associated with the remote commander and signal code information respectively corresponding to each of the one or more operational elements, the display information being based on the operational terminal information and the type information;
display, based on the display information, the one or more operational elements for selection by a user on a display screen; and,
transmit, based on the selection of a particular one of the one or more operational elements displayed on the display screen, a control signal for controlling an operation of a device, the control signal being transmitted in accordance with the signal code information respectively corresponding to the selected particular one of the one or more operational elements.

19. A method for operating a server, the method comprising:
receiving operational terminal information of an operational terminal and type information of a remote commander;
acquiring, based on the type information of the remote commander, signal code information respectively corresponding to each of one or more operational elements associated with the remote commander;
determining, using a processor and based on the operational terminal information, display information for displaying the one or more operational elements associated with the remote commander; and,
transmitting the display information and the signal code information respectively corresponding to each of the one or more operational elements.

20. A non-transitory computer-readable medium storing computer executable instructions of a program, the instructions, when executed by a control unit, configuring the control unit to:
receive operational terminal information of an operational terminal and type information of a remote commander;
acquire, based on the type information of the remote commander, signal code information respectively corresponding to each of one or more operational elements associated with the remote commander;
determine, based on the operational terminal information, display information for displaying the one or more operational elements associated with the remote commander; and,
transmit the display information and the signal code information respectively corresponding to each of the one or more operational elements.
